(19) United States
(12) Patent Application Publication
(10) Pub. No.: US 2025/0221347 A1
(43) Pub. Date: Jul. 10, 2025

(54) CONTROLLING TREE FELLING DIRECTION

(71) Applicant: Deere & Company, Moline, IL (US)

(72) Inventors: Sanket Pawar, Pune (IN); Adam G. Harwood, Dubuque, IA (US); Matthew J. Flood, Dubuque, IA (US)

(21) Appl. No.: 18/404,076

(22) Filed: Jan. 4, 2024

(51) Int. Cl. A01G 23/091

(52) U.S. Cl. CPC A01G 23/091

(57) ABSTRACT

A tree harvesting machine includes a system to monitor the felling direction of a felling head and determine whether the felling head is oriented toward a permissible felling zone when a tree is cut. If the felling head is oriented toward a permissible felling zone when a tree is cut the tree is allowed to be felled. If the felling head is not oriented toward a permissible felling zone when a tree is cut, the felling head is prevented from releasing the cut tree.

### FIELD OF THE DISCLOSURE

The present disclosure relates to a tree harvesting machine.

### BACKGROUND

One issue faced in the operation of any tree harvesting machine is controlling the tree felling direction, especially when felling trees by a roadside, on steep slopes, or in congested places. With traditional tree harvesting machines the felling head is in a dump mode as soon as a saw cut is commanded. The tree is felled immediately as soon as the saw passes through the trunk, unless the operator has taken positive action to do otherwise.

If the felling head cannot be oriented as needed to fell the tree in a desired direction, the operator needs to press multiple buttons to avoid felling the tree immediately upon cutting, and to then change the felling direction. The operator may override dump mode while cutting, then raise the felling head, then change the direction of the felling head before opening the felling head to allow the tree to fall.

### SUMMARY OF THE DISCLOSURE

The present disclosure provides a system which monitors the felling direction of the felling head and determines whether the felling head is oriented toward a permissible felling zone when a tree is cut. If the felling head is oriented toward a permissible felling zone when a tree is cut the tree is allowed to be felled. If the felling head is not oriented toward a permissible felling zone when a tree is cut, the felling head is prevented from releasing the cut tree. The operator does not have to override the dump mode prior to cutting.

In one embodiment a tree harvesting machine includes an undercarriage including a plurality of ground engaging units. An upper frame assembly is rotatably mounted on the undercarriage for rotation about a rotational axis relative to the undercarriage. A boom assembly is coupled to the upper frame assembly. A tree felling head is coupled to the boom assembly by a pivotal connection such that the tree felling head is pivotable about a pivot axis relative to the boom assembly. The tree felling head includes a frame, a saw coupled to the frame and configured to cut a tree, a grapple arm coupled to the frame, and at least one grapple arm actuator configured to move the grapple arm between a closed position in which the tree is held by the tree felling head and an open position in which the tree is released from the tree felling head. A pivot angle sensor is configured to detect a pivot angle of the tree felling head about the pivot axis relative to the boom assembly, and to generate a pivot angle signal corresponding to the pivot angle. A controller is configured to receive the pivot angle signal and to determine one or more ranges of the pivot angle defining one or more permissible felling zones. The controller is further configured to control the grapple arm actuator at least in part in response to the pivot angle signal to prevent the grapple arm from moving to the open position to fell the tree if the pivot angle signal corresponds to an orientation of the tree felling head directed outside of the one or more permissible felling zones.

In another embodiment a method of operating a tree harvesting machine is provided. The tree harvesting machine includes an undercarriage including a plurality of ground engaging units, an upper frame assembly rotatably mounted on the undercarriage for rotation about a rotational axis relative to the undercarriage, a boom assembly coupled to the upper frame assembly, and a tree felling head coupled to the boom assembly by a pivotal connection such that the tree felling head is pivotable about a pivot axis relative to the boom assembly. The tree felling head includes a frame, a saw coupled to the frame and configured to cut a tree, a grapple arm coupled to the frame, and at least one grapple arm actuator configured to move the grapple arm between a closed position in which the tree is held by the tree felling head and an open position in which the tree is released from the tree felling head. The method includes:
sensing with a pivot angle sensor a pivot angle of the tree felling head about the pivot axis relative to the boom assembly, and generating a pivot angle signal corresponding to the pivot angle;
receiving the pivot angle signal with an automatic controller;
determining with the automatic controller one or more ranges of the pivot angle defining one or more permissible felling zones; and
automatically controlling the grapple arm actuator at least in part in response to the pivot angle signal to prevent the grapple arm from moving to the open position to fell the tree if the pivot angle signal corresponds to an orientation of the tree felling head directed outside of the one or more permissible felling zones.

Numerous objects, features and advantages of the present invention will be readily apparent to those skilled in the art upon a review of following description in conjunction with the accompanying drawings.

### BRIEF DESCRIPTION OF THE DRAWINGS

FIG. 1 is a schematic left side view of a work vehicle, for example a tree harvesting machine including a felling head.

FIG. 2A is a perspective view of the felling head showing a cutting saw in a cutting position.

FIG. 2B is a perspective view of the felling head showing the cutting saw in a stored position.

FIG. 3A is a top view illustrating grapple arms of the felling head in a closed position.

FIG. 3B is a top view illustrating grapple arms of the felling head in a gliding position.

FIG. 3C is a top view illustrating grapple arms of the felling head in an open position.

FIG. 4 is a cross-section elevation view of the slew gear providing the pivotal connection of the felling head to the boom assembly.

FIG. 5 is a schematic drawing of a control system including the controller and its various inputs from the sensors and its various command outputs to the actuators of the machine.

FIG. 6A-6H are schematic plan views of the tree harvesting machine showing examples of possible permissible felling zones.

FIG. 7 is a schematic view of an input/output device in the form of a touch screen by which the human operator may input manual commands to the controller.

### DETAILED DESCRIPTION

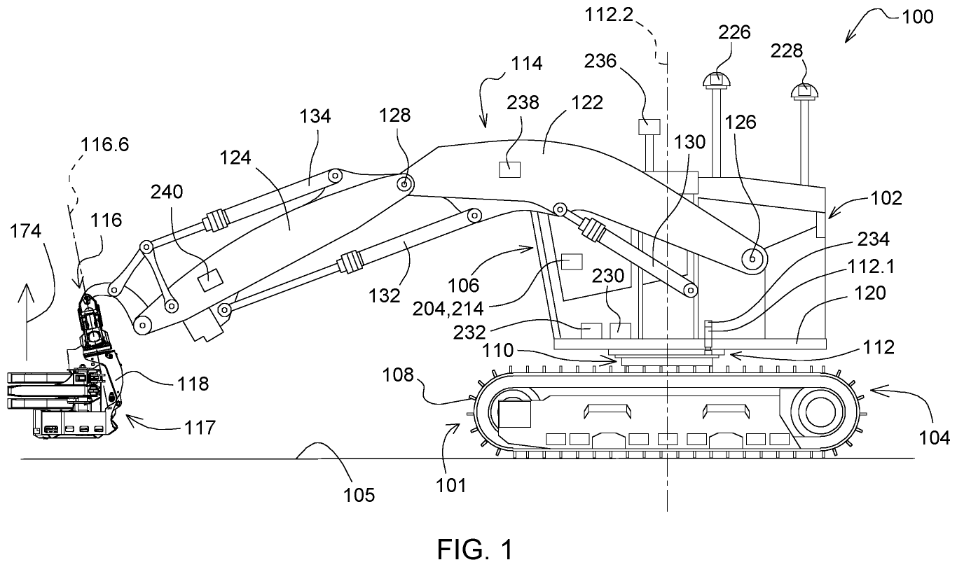

FIG. 1 illustrates a work vehicle 100 in the form of a tree harvesting machine 100 supported by an undercarriage 104 having a plurality of ground-engaging units 101. The ground-engaging units 101 are configured to support the work vehicle 100 on a ground surface 105. The illustrated ground-engaging units 101 are shown as tracks 108. Alternatively, the ground-engaging units 101 may be a set of front wheels and a set of rear wheels (not shown).

The tree harvesting machine 100 includes an upper frame assembly 102 which is supported by the tracks 108. The upper frame assembly 102 may include an operator's station 106. Alternatively, the operator may operate the tree harvesting machine 100 remotely. A plurality of operator inputs 214 (e.g., joysticks, pedals, buttons, screens) for controlling the tree harvesting machine 100 may be provided in the operator's station 106 as part of a control panel 204. The upper frame assembly 102 may also include an engine compartment that houses a prime mover (not shown). The prime mover may be a diesel engine, which provides power for operating the tree harvesting machine 100.

The upper frame assembly 102 may be mechanically coupled to the undercarriage 104 by a tilt mechanism and turntable assembly 110. The tilt mechanism and turntable assembly 110 operably controls the work vehicle 100 to be rotated and tilted about one or more axes. A swing assembly 112 includes one or more swing motors 112.1 for driving rotation of the upper frame assembly 102 relative to the undercarriage assembly 104 about a rotational axis 112.2. Operation of the swing assembly 112 rotates a platform 120 of the upper frame assembly 102 relative to the undercarriage 104.

With continued reference to FIG. 1, the tree harvesting machine 100 includes a boom assembly 114 that is coupled to the upper frame assembly 102. The boom assembly 114 may include a first boom section 122 and a second boom section 124. The first boom section 122 may be coupled to the upper frame assembly 102 via a first pivot joint 126. The first boom section 122 may be coupled to the second boom section 124 via a second pivot joint 128. The second boom section 124 may also be coupled to a wrist assembly 116.

To manipulate the position of the boom assembly 114 with respect to the upper frame assembly 102 the tree harvesting machine 100 includes a first boom actuator 130. One portion of the first boom actuator 130 is coupled to the upper frame assembly 102 and another portion is connected to the first boom section 122. A second boom actuator 132 may be coupled to the first boom section 122 and the second boom section 124 to pivot the second boom section 124 with respect to the first boom section 122. A third boom actuator 134 is coupled between the second boom section 124 and the wrist assembly 116. The position of the wrist assembly 116 is controlled by extending or retracting the first boom actuator 130, the second boom actuator 132 and the third boom actuator 134. In an exemplary scenario, to raise the wrist assembly 116 the first boom actuator 130 is extended which further pivots the boom assembly 114 about the first pivot joint 126.

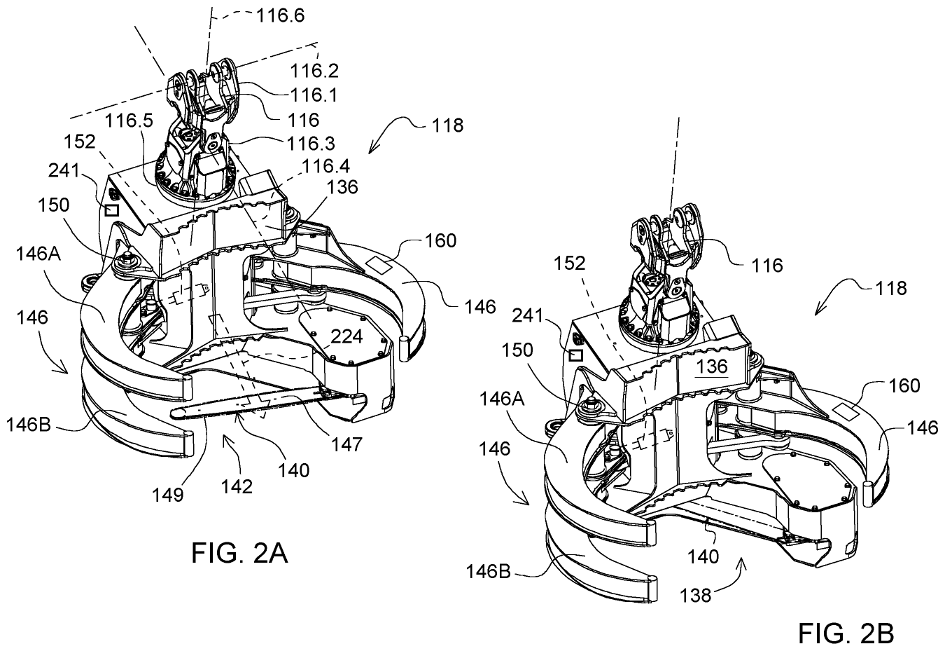

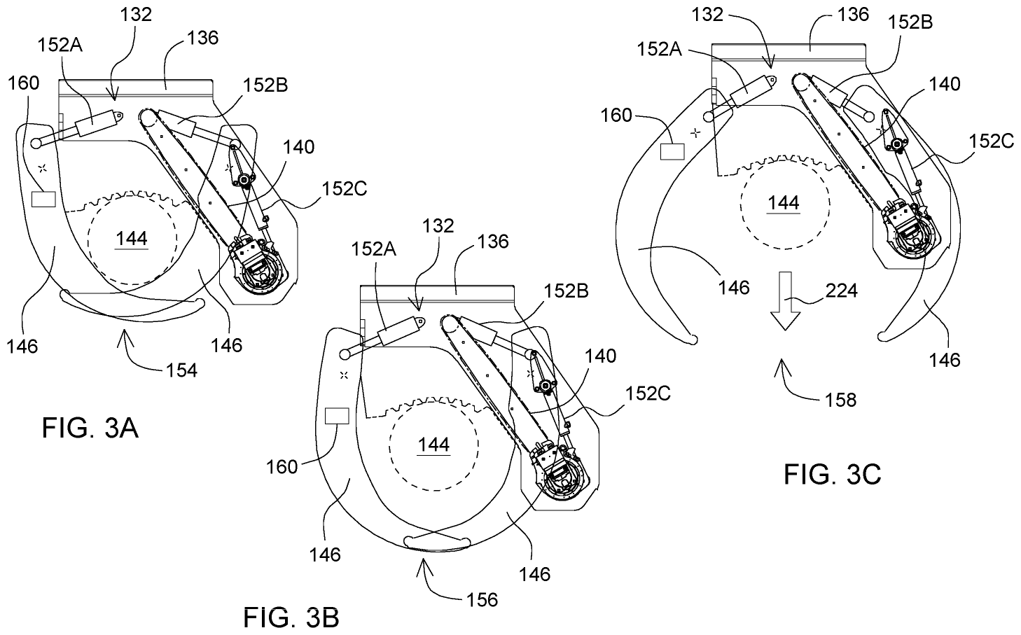

Referring to FIGS. 1, 2A, and 2B, a work implement 117 is coupled to the wrist assembly 116 of the boom assembly 114. The illustrated work implement 117 is a tree felling head 118 for harvesting a tree 144 (FIGS. 3A-3C). The tree felling head 118 comprises a frame 136 to support various components of the tree felling head 118. In the embodiment shown in FIGS. 2A-2B the frame 136 of the tree felling head 118 supports a saw 140 and a grapple arm 146. The frame 136 also supports a plurality of actuators 152A, 152B, 152C (FIGS. 3A-3C) to control the positions of the saw 140 and the grapple arm 146.

With continued reference to FIGS. 2A-2B, in one embodiment the saw 140 is coupled to the frame 136 and is configured to move from a stored position 138 (as shown in FIG. 2B) to a cutting position 142 (as shown in FIG. 2A) to cut the tree 144 (FIGS. 3A-3C). The saw 140 may be moved by a saw actuator 152C (FIGS. 3A-3C). The saw 140 may comprise a bar 147 and chain 149. The saw actuator 152C may be an electronic actuator, a hydraulic actuator, a hydraulic motor or an electric motor.

FIG. 2A illustrates the tree felling head 118 with the grapple arm 146. The grapple arm 146 is coupled to the frame 136 at an arm pivot joint 150. At least one grapple arm actuator 152 is coupled to the frame 136 and the grapple arm 146. The grapple arm actuator 152 may be an electric actuator or a hydraulic actuator. The grapple arm actuator 152 is configured to move the grapple arm 146 between a closed position 154 in which the tree 144 is held by the tree felling head 118 (FIG. 3A), a gliding position 156 in which the tree 144 is allowed to slide relative to the tree felling head 118 (FIG. 3B), and an open position 158 in which the tree 144 is released from the tree felling head 118 (FIG. 3C).

FIGS. 3A-3C illustrate three exemplary positions of the grapple arm 146. In the closed position 154 of the grapple arm 146 as shown in FIG. 3A, the grapple arm actuator 152 may be extended to a maximum limit such that the grapple arm 146 holds the tree 144 tightly to avoid any slip between the tree 144 and the grapple arm 146. In the gliding position 156 as shown in FIG. 3B, the grapple arm 146 is retracted some such that the grapple arm 146 may make a narrow gap between the grapple arm 146 and the tree 144. In this position, the tree 144 can slide with respect to the grapple arm 146. In the open position 158 as shown in FIG. 3C, the grapple arm actuator 152 is retracted such that the tree 144 falls from the tree felling head 118. As illustrated in FIGS. 2A-3C, the grapple arm 146 may comprise a pair of grapple arms 146A, 146B. and the grapple arm actuator 152 may comprise a pair of grapple arm actuators 152A, 152B. The pair of grapple arms 146A, 146B and the pair of grapple arm actuators 152A, 152B are connected to either side of the frame 136 such that the pair of grapple arms 146A, 146B are controlled by the respective grapple arm actuator 152A, 152B connected between the grapple arm 146 and the frame 136.

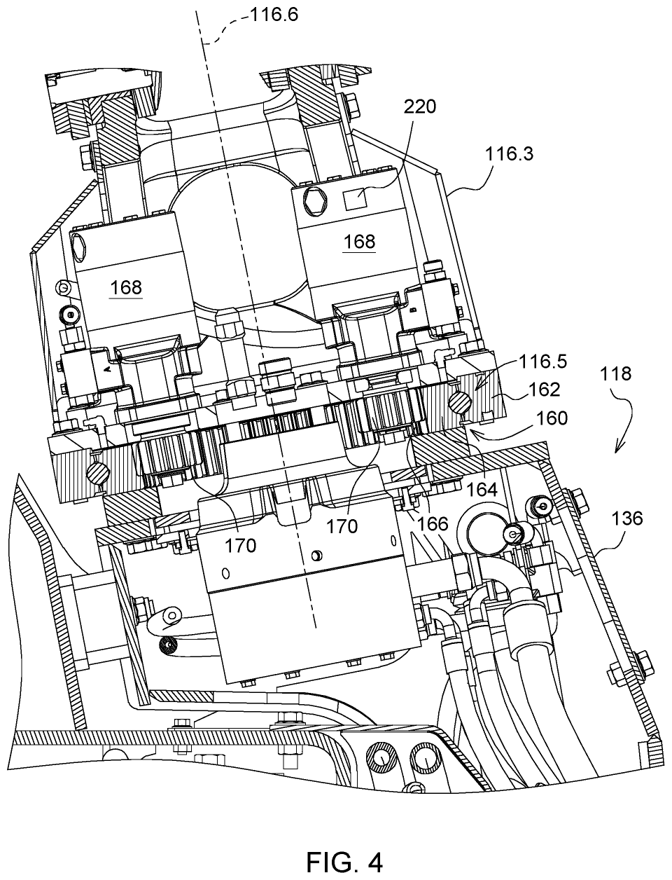

As seen in FIGS. 2A and 2B, the tree felling head 118 may be connected to the boom assembly 114 by the wrist assembly 116. The wrist assembly 116 includes an upper yoke 116.1 pivotally connected to the boom assembly 114 to pivot about a first yoke axis 116.2. A lower yoke 116.3 is pivotally connected to the upper yoke 116.1 to pivot about a second yoke axis 116.4 perpendicular to the first yoke axis 116.2. As best seen in FIG. 4, the frame 136 of the felling head 118 is pivotally connected to the lower yoke 116.3 and thus to the boom assembly 114 by pivotal connection 116.5 which defines a pivot axis 116.6. The pivot axis 116.6 is perpendicular to both the first and second yoke axes 116.2 and 116.4.

It will be appreciated that the pivot axis 116.6 between the boom assembly 114 and the felling head 118 will typically be oriented generally vertically when the tree harvesting machine 100 is resting on a horizontal ground surface 105 with the felling head 118 dangling from the boom assembly 114 under the influence of gravity. But the pivot axis 116.6 may be deflected from an exact vertical orientation by the various forces acting upon the felling head 118 and a tree 144 carried by the felling head 118. The universal joint action of the upper and lower yokes 116.1 and 116.3 of the wrist assembly 116 permits this deflection.

As is seen in FIG. 4, the pivotal connection 116.5 may be defined by a bearing race or slew gear 160 including an outer ring 162 attached to the lower yoke 116.3 and an inner ring 164 attached to the frame 136 of felling head 118. The inner ring 164 may be a ring gear having internal gear teeth 166 defined thereon. A pair of rotor drive motors 168 may be mounted on the lower yoke 116.3 and drive the inner ring gear 164 via drive pinion gears 170 to rotate the felling head 118 about the pivot axis 116.6.

### The Control System:

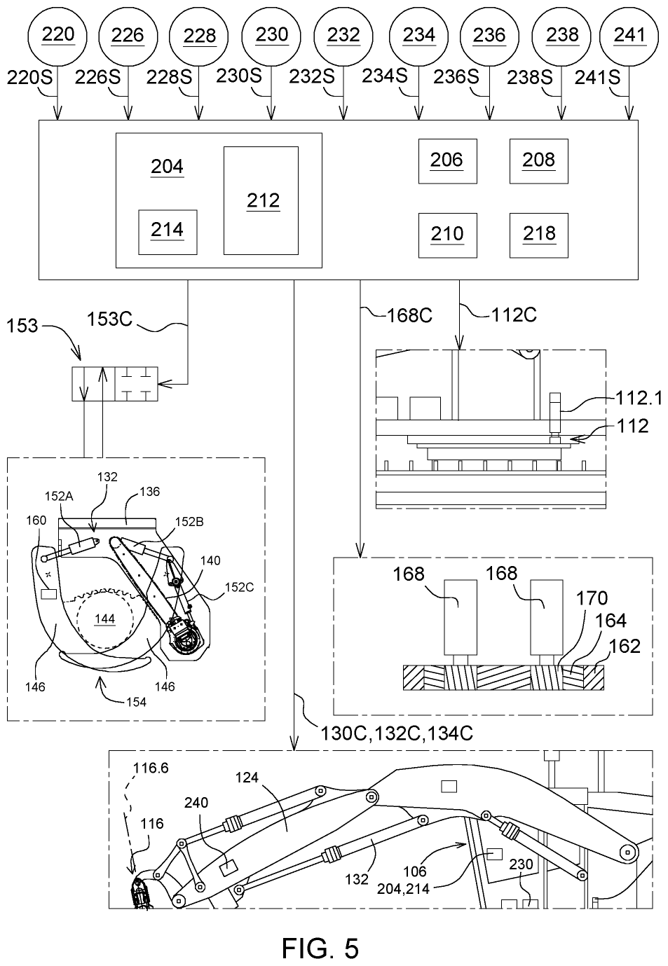

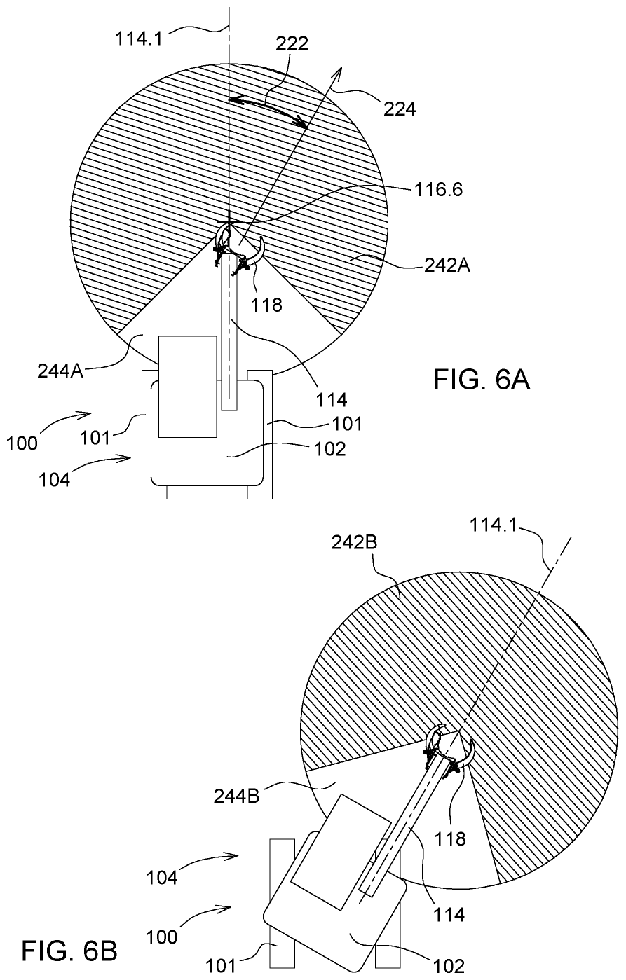

As schematically illustrated in FIG. 5, the tree harvesting machine 100 includes a control system 200 including a controller 202. The controller 202 may be part of the machine control system of the tree harvesting machine 100, or it may be a separate control module. The controller 202 may for example be mounted in a control panel 204 located at the operator's station 106. Controller 202 is functionally linked to various sensors to receive input signals from the various sensors. The signals transmitted from the various sensors to the controller 202 are schematically indicated in FIG. 5 by lines connecting the sensors to the controller with an arrowhead indicating the flow of the signal from the sensor to the controller 202. The control signals are identified by the sensor number followed by the suffix “S”.

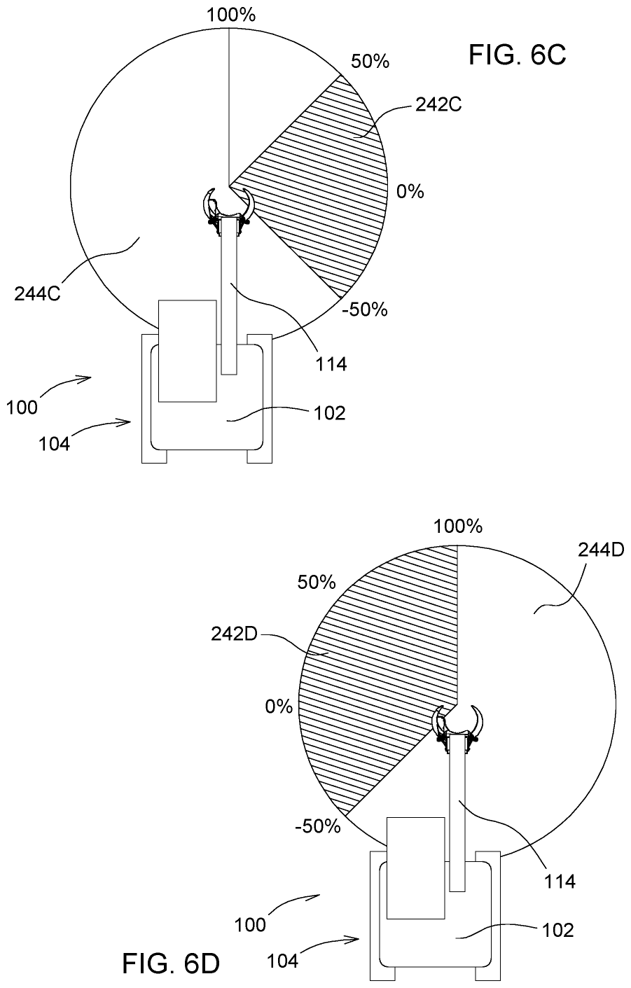

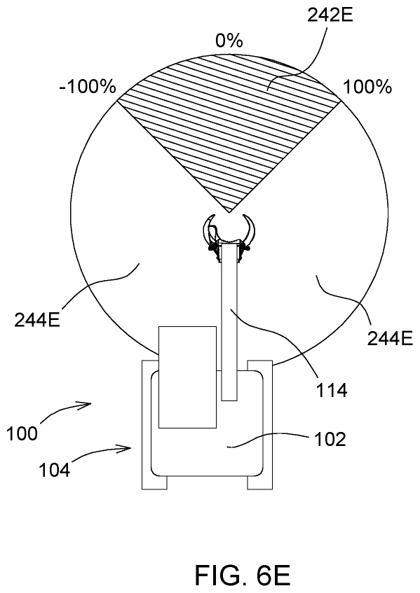

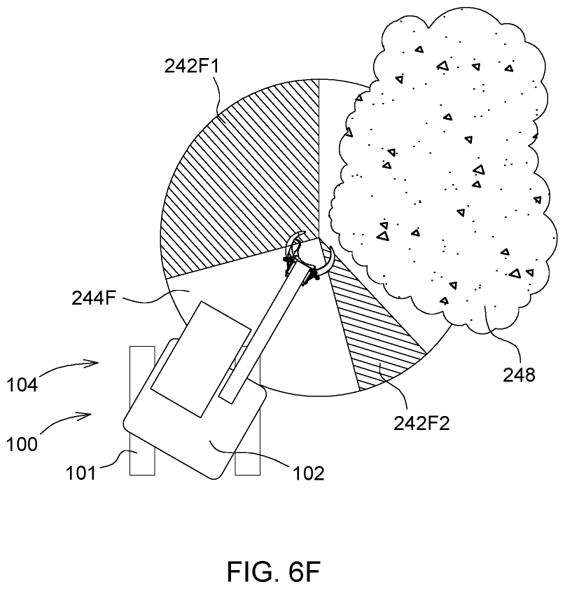

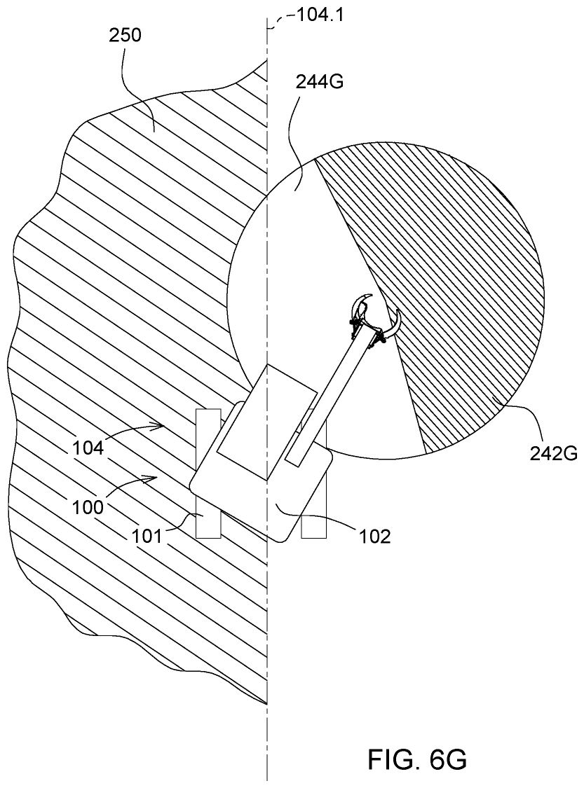

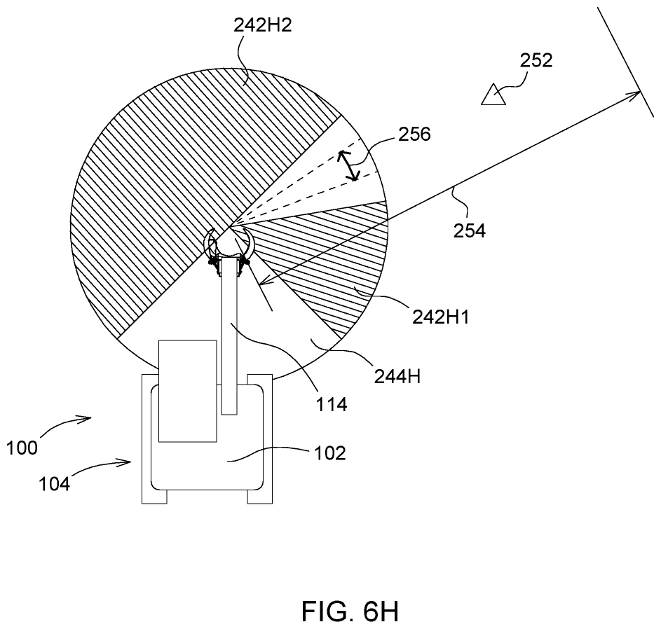

A pivot angle sensor 220 may be provided and configured to detect a pivot angle 222 (see FIG. 6A) of the tree felling head 118 about the pivot axis 116.6 relative to the boom assembly 114. The pivot angle sensor 220 may be configured to generate a pivot angle signal 220S corresponding to the pivot angle 222. The pivot angle 222 may be defined as an angle between a facing direction 224 in which the felling head 118 faces, and an arbitrary reference direction defined by the boom assembly 118. The facing direction 224 may be a central direction between the grappling arms 146 and facing outward from the felling head. It is assumed that when a tree 144 is cut and released it will fall forward in the facing direction 224 out of the grasp of the grappling arms 146. Thus, the felling angle 222 is illustrated in FIG. 6A as the angle between the facing direction 224 and a longitudinal axis 114.1 of the boom assembly 114.

As schematically shown in FIG. 4, the pivot angle sensor 220 may be associated with one of the rotor drive motors 168 to measure the rotational motion of the drive pinion 170 and thus of the ring gear 164 relative to the outer ring 162. Or the pivot angle sensor 220 may be any other suitable sensor which directly measures relative pivotal motion of felling head 118 about axis 116.6 relative to lower yoke 116.3 and relative to the boom assembly 114. As indicated in FIG. 5 the controller 202 will receive the pivot angle signal 220S and as further described below may use that information for control of the felling head 118.

As schematically shown in FIGS. 1 and 5, the tree harvesting machine 100 may include one or more position sensors 226 and 228 configured to detect a position and orientation of the upper frame assembly 102 within a reference system external to the tree harvesting machine 100. The external reference system may for example be the reference system defined using a satellite based global navigation satellite system (GNSS). Alternatively, the external reference system may be defined by a laser based reference system, or a Total System, or any other available external reference system. In the context of a GNSS system the position sensors 226 and 228 may be GNSS sensors suitable for receiving satellite position signals from which the position and orientation of the tree harvesting machine 100 on the face of the earth as defined by the GNSS satellite system may be determined. The position sensors 226 and 228 may generate position signals 226S and 228S which are received by the controller 202.

As schematically shown in FIGS. 1 and 5, the tree harvesting machine 100 may further include one or more orientation sensors 230 and 232 configured to detect an orientation of the upper frame assembly 102 relative to gravity so as to determine an uphill or downhill direction relative to the ground surface 105 on which the tree harvesting machine 100 is supported. The orientation sensors 230 and 232 may for example include a pair of slope sensors with the orientation sensor 230 detecting slope in a forward/rearward direction parallel to longitudinal axis 114.1 and with the orientation sensor 232 detecting cross-slope transverse to the longitudinal axis 114.1. The orientation sensors 230 and 232 will generate orientation signals 230S and 232S which are received by the controller 202.

As schematically shown in FIGS. 1 and 5, the tree harvesting machine 100 may further include a rotational angle sensor 234 configured to detect a rotational angle of the upper frame assembly 102 about the rotational axis 112.2 relative to the undercarriage 104. The rotational angle sensor 234 may for example be associated with the swing motor 112.1 which rotates the upper frame assembly 102. The rotational angle sensor 234 may generate a rotational angle signal 234S which is received by the controller 202.

As schematically shown in FIGS. 1 and 5, the tree harvesting machine 100 may further include one or more object or obstacle detection sensors 236 configured to detect an object or obstacle within a predetermined distance from the felling head 118 in a predetermined pivot angle range about the pivot axis 116.6. For example, the object or obstacle detection sensor 236 may be a vision sensor or a radar sensor mounted on the upper frame assembly 102. The object or obstacle detection sensor 236 may also be mounted on some portion of the boom assembly 114. The object or obstacle detection sensor 236 will generate an object or obstacle detection signal 236S which is received by the controller 202.

The tree harvesting machine may further include one or more boom position sensors 238 and 240 configured to detect an orientation of the various links 122 and 124 of the boom assembly 114. Boom position sensors 238 and 240 may for example be Inertial Measurement Units (IMU's) mounted on the first and second boom sections 122 and 124. Alternatively, boom position sensors 238 and 240 may be rotational sensors associated with the pivot joints 126 and 128. Or further alternatively the boom position sensors 238 and 240 may be extension sensors associated with the actuators 130 and 132, for example in the form of integrated extension sensors in a “smart” hydraulic cylinder. The boom position sensors 238 and 240 will generate boom position signals 238S and 240S received by controller 202 by means of which the controller 202 may determine the orientation of the boom sections 122 and 124 and thus the position of the felling head 118 relative to the upper frame assembly 102.

The tree harvesting machine may further include one or more vertical orientation sensors 241 configured to detect the orientation of the felling head 118 relative to gravity. The vertical orientation sensor 241 may for example be an IMU mounted on the frame 136 of the felling head 118 as schematically shown in FIGS. 2A and 2B. The vertical orientation sensor 241 could also be in the form of a rotary sensor configured to detect the position of felling head 118 about axis 116.2, used in combination with other position data from the boom position sensors 238 and 240. The vertical orientation sensor 241 provides signal 241S which allows the controller 202 to detect whether felling is completed by checking the vertical orientation of the felling head 118 in combination with the position of grapple arm actuators 152. The controller 202 may control the boom assembly 114 to return the felling head 118 to a vertical upright position after felling is completed.

Similarly, the controller 202 will generate control signals for controlling the operation of various actuators of the work vehicle 100. Those actuators may for example include the swing motor 112.1, the boom actuators 130, 132, 134, the rotor drive motors 168, the grapple arm actuators 152A and 152B, and the saw actuator 152C.

Controller 202 includes or may be associated with a processor 206, a computer readable medium 208, a data base 210 and the input/output module or control panel 204 having a display 212. An input/output device 214, such as a keyboard, joystick or other user interface, is provided so that the human operator may input instructions to the controller. It is understood that the controller 202 described herein may be a single controller having all of the described functionality, or it may include multiple controllers wherein the described functionality is distributed among the multiple controllers.

Various operations, steps or algorithms as described in connection with the controller 202 can be embodied directly in hardware, in a computer program product 218 such as a software module executed by the processor 206, or in a combination of the two. The computer program product 218 can reside in RAM memory, flash memory, ROM memory, EPROM memory, EEPROM memory, registers, hard disk, a removable disk, or any other form of computer-readable medium 208 known in the art. An exemplary computer-readable medium 208 can be coupled to the processor 206 such that the processor can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The data storage in computer readable medium 208 and/or database 210 may in certain embodiments include a database service, cloud databases, or the like. In various embodiments, the computing network may comprise a cloud server, and may in some implementations be part of a cloud application wherein various functions as disclosed herein are distributed in nature between the computing network and other distributed computing devices. Any or all of the distributed computing devices may be implemented as at least one of an onboard vehicle controller, a server device, a desktop computer, a laptop computer, a smart phone, or any other electronic device capable of executing instructions. A processor (such as a microprocessor) of the devices may be a generic hardware processor, a special-purpose hardware processor, or a combination thereof.

### Basic Mode of Operation:

The controller 202 may be configured via suitable programming of the computer program product 218 to control a tree felling direction of trees 144 cut and felled by the felling head 118. The controller 202 may receive the pivot angle signal 220S and may determine one or more ranges of the pivot angle 222 defining one or more permissible felling zones 242, as schematically represented in FIGS. 6A-6H for several examples.

In FIG. 6A, for example, a permissible felling zone 242A is defined which extends 135 degrees to either side of the forward extending longitudinal axis 114.1 of the boom assembly 114. The central axis of the permissible felling zone 242A may be defined by the pivot axis 116.6 of the wrist assembly 116. As previously noted, it is assumed that the tree 144 will fall forward in the facing direction 224 of the felling head 118.

It is further noted that by process of elimination the area 244 which falls outside of the permissible felling zone 242A may be referred to as a “no-fell” zone 244A. It will be appreciated that the controller 202 may be programmed to prevent felling in the “no-fell” zone 244A or to permit felling in the permissible felling zone 242A, both of which are equivalent and will have the identical result.

The example of FIG. 6A may be considered to be the maximum range permissible felling zone 242A, which simply prevents a tree from being felled in a direction falling generally back towards the tree harvesting machine 100.

Although in FIG. 6A the boom assembly 114 is shown as oriented directly forward from the undercarriage 104, it will be appreciated that this is not generally the case. The tree harvesting machine 100 as shown is of the type known as a “swing to tree” machine in which the felling head 118 may be moved relative to the undercarriage 104 to engage a tree 144. The boom assembly 114 may extend and retract along its longitudinal axis 114.1, and the upper frame assembly 102 with the boom assembly 114 may rotate about vertical axis 112.2 due to action of the swing assembly 112.

It is also helpful to an understanding of the improvements provided by the present disclosure to understand how felling heads have sometimes been operated in the past. One typical arrangement has been for the controls of the felling head to be configured such that the felling head is in a “dump mode” as soon as a saw cut is commanded so that the tree fells immediately as soon as the saw passes through the trunk of the tree. With such a system, if the human operator sees that the felling head is oriented in an undesirable direction, it is necessary for the human operator to manually override the “dump mode.” The operator may need to activate multiple manual inputs to first avoid felling the tree when it is cut, and then change the felling direction before reactivating the “dump mode” to all the tree to fall.

The present disclosure provides a system which will automatically monitor whether the felling head 118 is oriented in an acceptable direction 224 toward a defined permissible felling zone 242. If the felling head 118 is oriented toward a “no-fell” zone 244, the system will prevent the grapple arms 146 from moving to an open position to release the tree. The human operator can then take action to reorient the felling head 118 before releasing the tree.

It is noted that the grapple arm actuators 152 may be hydraulic grapple arm actuators controlled by a hydraulic dump valve 153 as schematically shown in FIG. 5. In this arrangement the controller 202 may be further configured to send a command signal 153C prevent the hydraulic dump valve 153 from moving the hydraulic grapple arm actuator 152 to the open position 158 to fell the tree 144 if the pivot angle signal 220S corresponds to an orientation 224 of the tree felling head 118 directed outside of the one or more permissible felling zones 242.

The controller 202 may generally be described as being configured to receive the pivot angle signal 220S and determine one or more ranges of the pivot angle 222 defining one or more permissible felling zones 242. The controller 202 is further configured to control the grapple arm actuator 252 at least in part in response to the pivot angle signal 220S to prevent the grapple arm 146 from moving to the open position 158 to fell the tree 144 if the pivot angle signal 220S corresponds to an orientation of the tree felling head 118 directed outside of the one or more permissible felling zones 242.

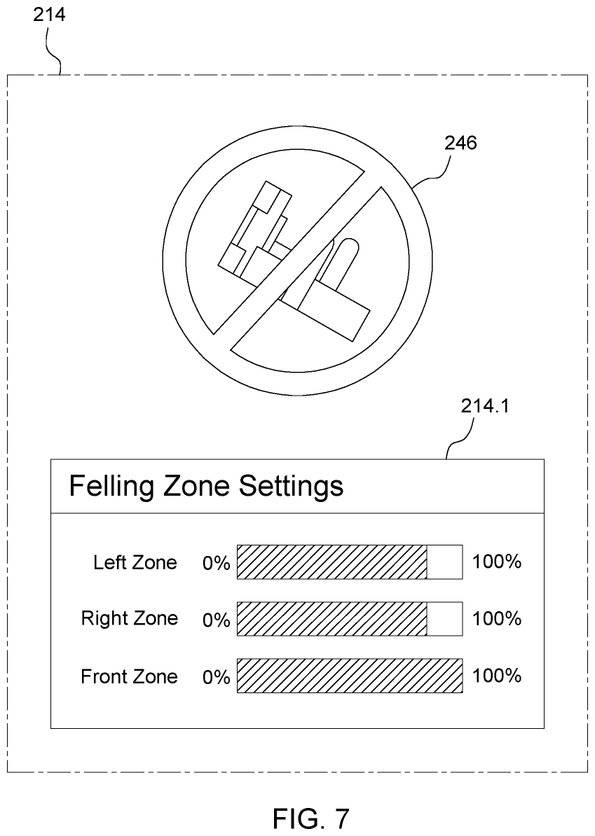

In one embodiment the control panel 204 may include the input/output device 214 in the form of an operator interface 214 configured to allow the human operator to input a manual instruction to at least in part define the one or more ranges of the pivot angle 222 defining the one or more permissible felling zones 242. For example, the operator interface 214 may take the form of a touch screen input 214.1 as seen in FIG. 7, wherein a “Left Zone”, a “Right Zone” and/or a “Front Zone” can be selected and a corresponding range set for that zone.

The controller 202 may be further configured to display to the human operator of the tree harvesting machine 100 a visual warning such as 246 when the pivot angle signal 220S corresponds to an orientation 222 of the tree felling head 118 directed outside of the one or more permissible felling zones 242.

FIG. 6C schematically illustrates a permissible felling zone 242C selected as a right side felling zone to the right side of the boom assembly 114. FIG. 6D schematically illustrates a permissible felling zone 242D selected as a left side felling zone to the left side of the boom assembly 114. FIG. 6E schematically illustrates a permissible felling zone 242E selected as a front side felling zone to the front of the boom assembly 114. If all of the left, right and front felling zones are selected together the result is the maximum possible permissible felling zone 242A shown in FIG. 6A.

Once the operator has selected the one or more permissible felling zones 242, the operator may proceed in a typical manner to cut and fell trees 144. If the controller 202 determines that the felling head 118 is facing in a facing direction 224 within the defined permissible felling zones 242, the cutting and felling will proceed. If the controller 202 determines that the felling head 118 is facing in a facing direction 224 outside of the defined permissible felling zones 242, the controller will prevent the grapple arms 146 from moving to the open position, and the controller 202 will display the visual warning 246. The controller 202 may also provide an audible warning, such as a horn. The human operator may then take action to reorient the felling head 118 to an acceptable orientation before releasing the tree and allowing it to fall.

For the example of FIG. 6A, if the permissible felling zone is defined with reference to the boom assembly 114 so as to prevent a felled tree from falling back toward the tree harvesting machine 100, the permissible felling zone orientation relative to the boom assembly 114 may stay the same regardless of the orientation of the boom assembly 114 relative to the undercarriage 104. Thus, if the boom assembly 114 pivots to the right side of the machine as shown in FIG. 6B, the orientation of the permissible felling zone 242B is unchanged relative to the boom assembly 114, although it is changed relative to the undercarriage 104.

In the basic mode of operation the method of the present disclosure may be described as including:
sensing with the pivot angle sensor 220 the pivot angle 222 of the tree felling head 118 about the pivot axis 116.6 relative to the boom assembly 114, and generating the pivot angle signal 220S corresponding to the pivot angle 222;
receiving the pivot angle signal 220S with the automatic controller 202;
determining with the automatic controller 202 one or more ranges of the pivot angle 222 defining one or more permissible felling zones 242; and
automatically controlling the grapple arm actuator 152 at least in part in response to the pivot angle signal 220S to prevent the grapple arm 146 from moving to the open position 158 to fell the tree 144 if the pivot angle signal 220S corresponds to an orientation 224 of the tree felling head 118 directed outside of the one or more permissible felling zones 242.

The basic mode of operation may further include a step of inputting via the operator interface 214 a manual instruction at least in part defining the one or more ranges of the pivot angle 222 defining the one or more permissible felling zones 242.

On the other hand, some permissible felling zones will be defined based on parameters which are independent of the orientation of the boom assembly 114. Depending on the defining parameters of the permissible felling zone, the orientation of the permissible felling zone relative to the end of the boom assembly 114 may change as the felling head is moved relative to the undercarriage 104. This is shown in the following examples.

### Uphill/Downhill Control Mode:

One mode of operation which may involve control parameters independent of the orientation of the boom assembly 114, may provide for a control mode which can selectively fell all trees in an uphill or a downhill orientation based upon the topography of the ground.

This mode of operation may rely upon orientation signals 230S and 232S from the orientation sensors 230 and 232 to determine the “uphill” and/or “downhill” direction relative to the tree felling machine 100. The sensors 230 and 232 may be described as one or more orientation sensors 230, 232 configured to detect an orientation of the upper frame assembly 102 relative to gravity so as to determine an uphill or downhill direction relative to a ground surface 105 on which the tree harvesting machine 100 is supported.

In this mode of operation the controller 202 may be configured to determine the one or more ranges of the pivot angle 222 defining the one or more permissible felling zones 242 at least in part based upon the orientation of the upper frame assembly 102 relative to gravity so that the tree 144 is felled in a selected uphill or downhill direction. It will be appreciated that the “uphill/down hill” control mode may have a “no-fell” zone superimposed thereon to prevent the trees from falling toward the tree felling machine 100.

In the uphill/down hill mode of operation the method of the present disclosure may be described as including:
detecting with one or more orientation sensors 230, 232 an orientation of the upper frame assembly 102 relative to gravity and thereby determining an uphill or downhill direction relative to the ground surface 105 on which the tree harvesting machine 100 is supported; and
   determining with the automatic controller 202 the one or more ranges of the pivot angle 222 defining the one or more permissible felling zones 242 at least in part based upon the orientation of the upper frame assembly 102 relative to gravity so that the tree 144 is felled in a selected uphill or downhill direction.

### Timber Management Software:

Another mode of operation which may involve control parameters independent of the orientation of the boom assembly 114, may provide for a control mode which uses information from a timber management software program defining one or more no fell areas in the reference system external to the tree harvesting machine 100.

In this mode of operation the controller 202 may determine the position and orientation of the upper frame assembly 102 within the reference system external to the tree harvesting machine 100 based on the position signals 226S and 228S from the GNSS position sensors 226 and 228. The controller 202 may be configured to determine the one or more ranges of the pivot angle 222 defining the one or more permissible felling zones 242 at least in part based upon the position of the upper frame assembly 102 within the reference system external to the tree harvesting machine 100 and the one or more no fell areas in the reference system external to the tree harvesting machine.

For example, as schematically shown in FIG. 6F, the timber management software may define a geographic area 248 as a “no-fell” area. The “no-fell” area 248 may for example be populated with recently planted young trees which need to be protected against damage from the surrounding mature trees when the mature trees are harvested. The controller 202 may then define permissible felling zones 242F1 and 242F2 lying outside of the “no-fell” area 248 and also falling away from the tree harvesting machine 100. It will be appreciated that as the boom assembly 114 swings from one tree to another the defined permissible felling zones 242F1 and 242F2 will change relative to the boom assembly 114.

In the timber management mode of operation the method of the present disclosure may be described as including:
detecting with one or more position sensors 226, 228 a position and orientation of the upper frame assembly 102 within the reference system (e.g. the GNSS reference system) external to the tree harvesting machine 100;
providing to the automatic controller 202 a timber management software 218 defining one or more no fell areas 248 in the reference system external to the tree harvesting machine; and
determining with the automatic controller 202 the one or more ranges of the pivot angle 222 defining the one or more permissible felling zones 242F1 and 242F2 at least in part based upon the position of the upper frame assembly 102 within the reference system external to the tree harvesting machine 100 and the one or more no fell areas 248 in the reference system external to the tree harvesting machine 100.

### Left Side/Right Side Felling Mode:

Another mode of operation which may involve control parameters independent of the orientation of the boom assembly 114, may provide for a control mode which defines the permissible felling zones at least in part based upon the orientation of the undercarriage 104. For example it may be desired to fell all the trees to the right side of the tracks 108 of the tree harvesting machine 100.

In this situation the controller 202 may monitor the rotational position of the upper frame assembly 102 relative to the undercarriage 104 using the rotational angle sensor 234. As schematically shown in FIG. 6G, if it is desired to fell all trees to the right side of the undercarriage 104, the controller 202 may define the geographic area to the left of a centerline 104.1 of the undercarriage 104 as a no-fell area 250.

The controller 202 may be configured to receive the rotational angle signal 234S, and to determine the one or more ranges of the pivot angle 222 defining the one or more permissible felling zones 242G at least in part based upon the rotational angle signal 234S so that the tree 144 is felled to the right side of the undercarriage 104.

In the left side/right side felling mode of operation the method of the present disclosure may be described as including:
detecting with the rotational angle sensor 234 the rotational angle 222 of the upper frame assembly 102 about the rotational axis 112.2 relative to the undercarriage 104, and generating the rotational angle signal 234S corresponding to the rotational angle 222;
receiving the rotational angle signal 234S with the automatic controller 202, and automatically determining the one or more ranges of the pivot angle 222 defining the one or more permissible felling zones 242G at least in part based upon the rotational angle signal 234S so that the tree 144 is felled to a selected side of the undercarriage 104.

### Obstacle Avoidance Mode:

Another mode of operation which may involve control parameters independent of the orientation of the boom assembly 114, may provide for a control mode which defines the permissible felling zones at least in part to avoid felling a tree toward a detected obstacle 252. This is schematically shown in FIG. 6H. The controller 202 may receive the object detection signal 236S from the object detection sensor 236 so as to detect an obstacle 252 within a predetermined distance 254 from the felling head 118 in a detected pivot angle range 256 about the pivot axis 116.6. For example, the controller 202 may receive information defining the expected height of the tree to be cut, and may use the object detection sensor 236 to determine whether the tree will fall on a detected obstacle in its path. If the controller 202 determines that an obstacle 252 lies in the path of the present facing direction 224 of the felling head 118 the controller may define that facing direction as falling within a no-fell zone and thus being outside of the permissible felling zone. The controller 202 may receive one or more such object detection signals 236S and based on that collective information define one or more permissible felling zones 242H1 and 242H2 which do not include such obstacles 252.

In the left side/right side felling mode of operation the method of the present disclosure may be described as including:
detecting with the obstacle detection sensor 236 a presence or absence of an obstacle 252 within a predetermined distance 254 from the felling head 118 in a detected pivot angle range 256 about the pivot axis 116.6, and generating an obstacle detection signal 236S; and
receiving the object detection signal 236S with the automatic controller 202, and automatically determining the one or more ranges of the pivot angle 222 defining the one or more permissible felling zones 242H1 and 242H2 at least in part based upon the object detection signal 236S.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1: A tree harvesting machine, comprising:
an undercarriage including a plurality of ground engaging units;
an upper frame assembly rotatably mounted on the undercarriage for rotation about a rotational axis relative to the undercarriage;
a boom assembly coupled to the upper frame assembly;
a tree felling head coupled to the boom assembly by a pivotal connection such that the tree felling head is pivotable about a pivot axis relative to the boom assembly, the tree felling head including a frame, a saw coupled to the frame and configured to cut a tree, a grapple arm coupled to the frame, and at least one grapple arm actuator configured to move the grapple arm between a closed position in which the tree is held by the tree felling head and an open position in which the tree is released from the tree felling head;
a pivot angle sensor configured to detect a pivot angle of the tree felling head about the pivot axis relative to the boom assembly, and to generate a pivot angle signal corresponding to the pivot angle; and
a controller configured to:
receive the pivot angle signal;
determine one or more ranges of the pivot angle defining one or more permissible felling zones; and
control the grapple arm actuator at least in part in response to the pivot angle signal to prevent the grapple arm from moving to the open position to fell the tree if the pivot angle signal corresponds to an orientation of the tree felling head directed outside of the one or more permissible felling zones.

2: The tree harvesting machine of claim 1, further comprising:
an operator interface configured to allow a human operator to input a manual instruction to at least in part define the one or more ranges of the pivot angle defining the one or more permissible felling zones.

3: The tree harvesting machine of claim 1, further comprising:
one or more position sensors configured to detect a position and orientation of the upper frame assembly within a reference system external to the tree harvesting machine;
wherein the controller includes a timber management software defining one or more no fell areas in the reference system external to the tree harvesting machine; and
wherein the controller is configured to determine the one or more ranges of the pivot angle defining the one or more permissible felling zones at least in part based upon the position of the upper frame assembly within the reference system external to the tree harvesting machine and the one or more no fell areas in the reference system external to the tree harvesting machine.

4: The tree harvesting machine of claim 1, further comprising:
one or more orientation sensors configured to detect an orientation of the upper frame assembly relative to gravity so as to determine an uphill or downhill direction relative to a ground surface on which the tree harvesting machine is supported; and
wherein the controller is configured to determine the one or more ranges of the pivot angle defining the one or more permissible felling zones at least in part based upon the orientation of the upper frame assembly relative to gravity so that the tree is felled in a selected uphill or downhill direction.

5: The tree harvesting machine of claim 1, further comprising:
a rotational angle sensor configured to detect a rotational angle of the upper frame assembly about the rotational axis relative to the undercarriage, and to generate a rotational angle signal corresponding to the rotational angle;
wherein the controller is further configured to receive the rotational angle signal, and to determine the one or more ranges of the pivot angle defining the one or more permissible felling zones at least in part based upon the rotational angle signal so that the tree is felled to a selected side of the undercarriage.

6: The tree harvesting machine of claim 1, further comprising:
an obstacle detection sensor configured to detect an obstacle within a predetermined distance from the felling head in a detected pivot angle range about the pivot axis, and to generate an obstacle detection signal; and
wherein the controller is further configured to receive the object detection signal, and to determine the one or more ranges of the pivot angle defining the one or more permissible felling zones at least in part based upon the object detection signal.

7: The tree harvesting machine of claim 6, wherein:
the object detection sensor is a vision sensor or a radar sensor.

8: The tree harvesting machine of claim 1, wherein:
the at least one grapple arm actuator includes a hydraulic grapple arm actuator controlled by a hydraulic dump valve; and
the controller is further configured to prevent the hydraulic dump valve from moving the hydraulic grapple arm actuator to the open position to fell the tree if the pivot angle signal corresponds to an orientation of the tree felling head directed outside of the one or more permissible felling zones.

9: The tree harvesting machine of claim 1, wherein:
the controller is further configured to display to a human operator of the tree harvesting machine a warning when the pivot angle signal corresponds to an orientation of the tree felling head directed outside of the one or more permissible felling zones.

10: The tree harvesting machine of claim 1, wherein:
the pivotal connection between the tree felling head and the boom assembly is part of a wrist assembly including an upper yoke pivotally connected to the boom assembly to pivot about a first yoke axis, a lower yoke pivotally connected to the upper yoke to pivot about a second yoke axis perpendicular to the first yoke axis, and wherein the pivotal connection between the tree felling head and the boom assembly is defined between the tree felling head and the lower yoke, the pivotal axis of the pivotal connection between the tree felling head and the boom assembly being perpendicular to both the first and second yoke axes.

11. A method of operating a tree harvesting machine, the tree harvesting machine including an undercarriage including a plurality of ground engaging units, an upper frame assembly rotatably mounted on the undercarriage for rotation about a rotational axis relative to the undercarriage, a boom assembly coupled to the upper frame assembly, a tree felling head coupled to the boom assembly by a pivotal connection such that the tree felling head is pivotable about a pivot axis relative to the boom assembly, the tree felling head including a frame, a saw coupled to the frame and configured to cut a tree, a grapple arm coupled to the frame, and at least one grapple arm actuator configured to move the grapple arm between a closed position in which the tree is held by the tree felling head and an open position in which the tree is released from the tree felling head, the method comprising:
sensing with a pivot angle sensor a pivot angle of the tree felling head about the pivot axis relative to the boom assembly, and generating a pivot angle signal corresponding to the pivot angle;
receiving the pivot angle signal with an automatic controller;
determining with the automatic controller one or more ranges of the pivot angle defining one or more permissible felling zones; and
automatically controlling the grapple arm actuator at least in part in response to the pivot angle signal to prevent the grapple arm from moving to the open position to fell the tree if the pivot angle signal corresponds to an orientation of the tree felling head directed outside of the one or more permissible felling zones.

12: The method of claim 11, further comprising:
inputting via an operator interface a manual instruction at least in part defining the one or more ranges of the pivot angle defining the one or more permissible felling zones.

13: The method of claim 11, further comprising:
detecting with one or more position sensors a position and orientation of the upper frame assembly within a reference system external to the tree harvesting machine;
providing to the automatic controller a timber management software defining one or more no fell areas in the reference system external to the tree harvesting machine; and
determining with the automatic controller the one or more ranges of the pivot angle defining the one or more permissible felling zones at least in part based upon the position of the upper frame assembly within the reference system external to the tree harvesting machine and the one or more no fell areas in the reference system external to the tree harvesting machine.

14: The method of claim 11, further comprising:
detecting with one or more orientation sensors an orientation of the upper frame assembly relative to gravity and thereby determining an uphill or downhill direction relative to a ground surface on which the tree harvesting machine is supported; and
determining with the automatic controller the one or more ranges of the pivot angle defining the one or more permissible felling zones at least in part based upon the orientation of the upper frame assembly relative to gravity so that the tree is felled in a selected uphill or downhill direction.

15: The method of claim 11, further comprising:
detecting with a rotational angle sensor a rotational angle of the upper frame assembly about the rotational axis relative to the undercarriage, and generating a rotational angle signal corresponding to the rotational angle;
receiving the rotational angle signal with the automatic controller, and automatically determining the one or more ranges of the pivot angle defining the one or more permissible felling zones at least in part based upon the rotational angle signal so that the tree is felled to a selected side of the undercarriage.

16: The method of claim 11, further comprising:
detecting with an obstacle detection sensor a presence or absence of an obstacle within a predetermined distance from the felling head in a detected pivot angle range about the pivot axis, and generating an obstacle detection signal; and
receiving the object detection signal with the automatic controller, and automatically determining the one or more ranges of the pivot angle defining the one or more permissible felling zones at least in part based upon the object detection signal.

17: The method of claim 16, wherein:
the object detection sensor is a vision sensor or a radar sensor.

18: The method of claim 11, wherein the at least one grapple arm actuator includes a hydraulic grapple arm actuator controlled by a hydraulic dump valve, wherein:
the automatically controlling step includes automatically preventing, with the automatic controller, the hydraulic dump valve from moving the hydraulic grapple arm actuator to the open position to fell the tree if the pivot angle signal corresponds to an orientation of the tree felling head directed outside of the one or more permissible felling zones.

19: The method of claim 11, further comprising:
displaying to a human operator of the tree harvesting machine a warning when the pivot angle signal corresponds to an orientation of the tree felling head directed outside of the one or more permissible felling zones.

20: The method of claim 11, wherein the pivotal connection between the tree felling head and the boom assembly is part of a wrist assembly including an upper yoke pivotally connected to the boom assembly to pivot about a first yoke axis, a lower yoke pivotally connected to the upper yoke to pivot about a second yoke axis perpendicular to the first yoke axis, and wherein the pivotal connection between the tree felling head and the boom assembly is defined between the tree felling head and the lower yoke, the pivotal axis of the pivotal connection between the tree felling head and the boom assembly being perpendicular to both the first and second yoke axes.
